(19) United States
(12) Patent Application Publication
(10) Pub. No.: US 2022/0192203 A1
(43) Pub. Date: Jun. 23, 2022

(54) Dough kneading device

(71) Applicant: BackNet GmbH, Bielefeld (DE)

(72) Inventor: Alexander MEIER, Dürrwangen (DE)

(73) Assignee: BackNet GmbH, Bielefeld (DE)

(21) Appl. No.: 17/557,906

(22) Filed: Dec. 21, 2021

(30) Foreign Application Priority Data
Dec. 23, 2020 (DE) 10 2020 216 527.0

(51) Int. Cl. A21C 1/14; A21C 1/06; A21C 1/08; A21C 5/00

(52) U.S. Cl. CPC A21C 1/1495; A21C 1/06; A21C 1/1405; A21C 1/1425; A21C 5/00; A21C 1/08

(57) ABSTRACT

A dough kneading device has a kneading drum for predefining the bottoms and side walls of kneading chambers, which serve to receive dough pieces to be kneaded. A kneading belt over a circumferential portion abuts the kneading drum for closing the kneading chambers. The kneading belt has a plurality of passage openings with a typical diameter which is smaller than 12 mm. This results in a dough kneading device with which even moist doughs can be kneaded without the use of anti-adhesive agents, if possible, without the dough adhering to the kneading belt and/or the kneading chambers in an unwanted manner.

### CROSS-REFERENCES TO RELATED APPLICATIONS

This application claims the priority of German Patent Application, Serial No. 10 2020 216 527.0, filed Dec. 23, 2020, the content of which is included herein by reference in its entirety as if fully set forth herein.

### FIELD OF THE INVENTION

The invention relates to a dough kneading device.

### BACKGROUND OF THE INVENTION

A dough kneading device of this type is known from EP 3 363 291 B1. DE-PS 1 053 437 discloses a kneading belt made of flexible fabric, for dough kneading machines.

### SUMMARY OF THE INVENTION

It is an object of the present disclosure to further design a dough kneading device of the type mentioned at the beginning in such a way that even moist doughs can be kneaded without the use of anti-adhesive agents, if possible, without the dough adhering to the kneading belt and/or the kneading chambers in an unwanted manner.

This object is achieved by a dough kneading device
with a kneading drum for predefining the bottoms and side walls of kneading chambers for receiving dough pieces to be kneaded,
with a kneading belt which over a circumferential portion abuts the kneading drum for closing the kneading chambers, wherein
the kneading belt has a plurality of passage openings with a typical diameter which is smaller than 12 mm, wherein the kneading belt with the passage openings is designed in such a way that, via the use of the kneading belt with the passage openings, a contact surface between the kneading belt and the dough pieces to be kneaded is reduced during operation of the dough kneading device.

It has been found that a contact surface between the kneading belt and the dough pieces to be kneaded can be reduced during operation of the dough kneading device by using a kneading belt with passage openings. Surprisingly, this does not lead to clogging of the passage openings, but actually to reduced adhesion of the dough pieces to be kneaded to the kneading belt, so that unwanted adhesion of the dough pieces to kneading components of the dough kneading device is reduced or completely avoided. A maximum limit of a typical diameter of the passage openings of 12 mm has proven to be particularly suitable to prevent clogging of the passage openings on the one hand and to avoid unwanted dough piece adhesion on the other hand.

The passage openings are in particular so large that at least a certain air permeability of the kneading belt is achieved. The typical diameter of the passage openings is the diameter of a circle with the same surface area as the respective passage opening area. The typical diameter of the passage openings can be smaller than 10 mm, can be smaller than 8 mm and can also be smaller than 5 mm. The typical diameter of the passage openings may be larger than 0.1 mm.

The passage openings serve for reducing a contact surface between the kneading belt and the dough pieces to be kneaded.

A woven kneading belt with passage openings between the warp and/or the weft yarns of a fabric of the kneading belt also leads to a desired reduction in the contact surface of the kneading belt on the dough pieces to be kneaded and to a reduction in the tendency to adhere.

A minimum limit for the typical passage opening diameter of more than 0.5 mm has proven to be particularly advantageous. The typical diameter may be larger than 1 mm and may also be larger than 2 mm.

Passage opening designs embodied in a round, polygonal shape (corners also with or without radius), of equal and unequal side lengths, or in an oval shape, with an elongated hole (equal and unequal) have proven themselves in practice, on the one hand, and can be manufactured with reasonable effort, on the other hand. Alternatively or additionally, the passage openings can be designed hexagonally. In a polygonal design of the passage openings, these can have equal and unequal side lengths. It is also possible to divide the passage openings by means of central webs or cross struts, wherein the typical diameter then refers to the resulting partial passage openings.

Arrangements of the passage openings in the manner of a hexagonal grid and in rows and/or columns, wherein at least some of the passage opening rows succeeding one another in the running direction of the kneading belt and extending transversely to the running direction are arranged offset from one another, additionally reduce a tendency to clog, as this makes it possible that a certain outer surface portion of the dough piece is carried along with equal probability by the kneading belt in the region of a passage opening or in the region between the passage openings during kneading. Experience has shown that this reduces the tendency of the dough to clog or to adhere.

A completely random distribution of the arrangement of the passage openings or an otherwise irregular and/or asymmetrical and/or aperiodic passage opening arrangement is also possible.

A kneading belt having multiple types of passage openings of different sizes, has corresponding advantages.

At least one blower for blowing drying air onto the kneading belt and/or the kneading chambers, additionally reduces a tendency of the dough to adhere and/or to clog.

The drying air can be cold air and/or warm air, depending on the blower design. A temperature of the drying air can be at most 60°. An air volume of the drying air may be larger than 50 m³/h and may in particular be larger than 200 m³/h, 500 m³/h or 1000 m³/h. The air volume is regularly smaller than 3000 m³/h.

For example, in the case of firmer doughs or doughs containing fat/oil, these doughs can also be processed without a blower. This generally applies to doughs with low dough yields, where a comparatively small amount of liquid per dough weight is used in dough production. Blower arrangements of at least one of the blowers in such a way that the drying air exclusively impinges on the kneading belt, in such a way that the drying air exclusively impinges on the kneading chambers and in such a way that the drying air impinges on the kneading chambers in the circumferential portion over which the kneading belt abuts the kneading drum for closing the kneading chambers have proven particularly effective for reducing a tendency to adhere and/or to clog.

The advantages of a dough dividing and kneading device with a dough dividing device and a dough kneading device according to the disclosure correspond to those which have already been discussed above with reference to the dough kneading device.

Further features, details and advantages of the invention will be apparent from the following description of an embodiment with reference to the accompanying drawings.

### BRIEF DESCRIPTION OF THE DRAWINGS

FIG. 1 shows a schematic side view of a dough processing device designed as a dough dividing/kneading device with a dough dividing device, a transfer device and a dough kneading device with a kneading drum and a kneading belt;

FIG. 2 shows details of a kneading belt guide of the dough kneading device as well as an arrangement of blowers for blowing the kneading belt and kneading chambers with drying air;

FIG. 3 shows a view of the kneading drum/kneading belt combination according to FIG. 2 from view direction III in FIG. 2, wherein the blowers are not shown;

FIG. 4 shows a broken view of the kneading belt/kneading drum combination according to FIG. 2 from view direction IV in FIG. 2, wherein the blowers are not shown;

FIG. 5 shows a sectioned detail view according to line V-V in FIG. 2 with a circumferential portion of the kneading drum which the kneading belt abuts; and

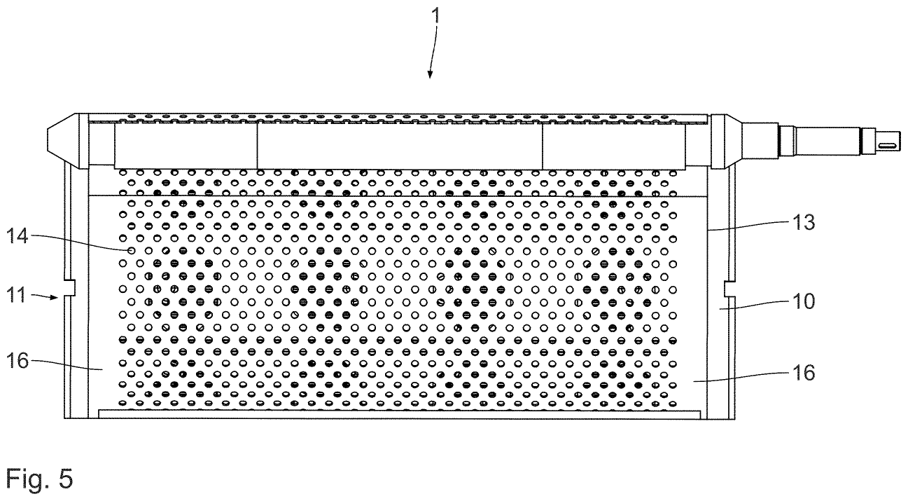

FIG. 6 perspectively shows the arrangement according to FIG. 2 including the blowers.

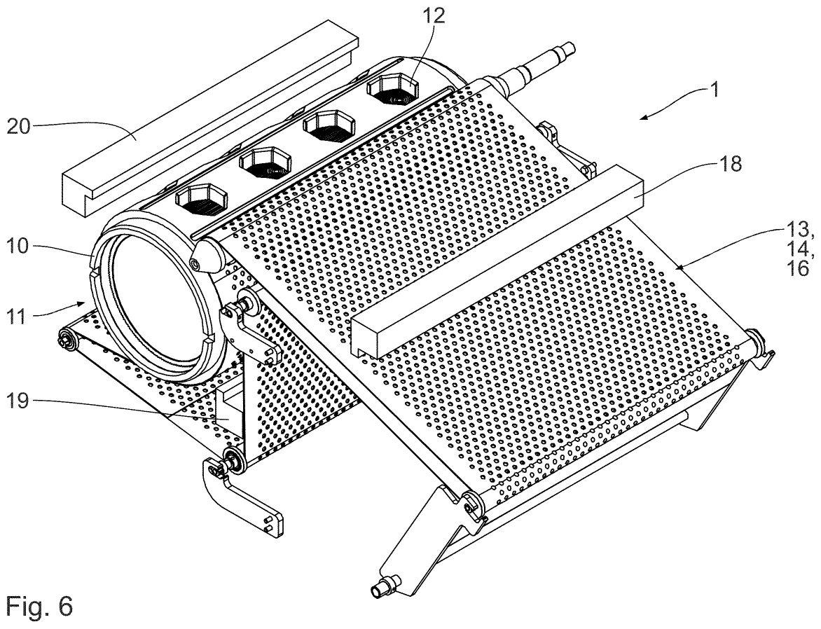

### DESCRIPTION OF THE PREFERRED EMBODIMENT

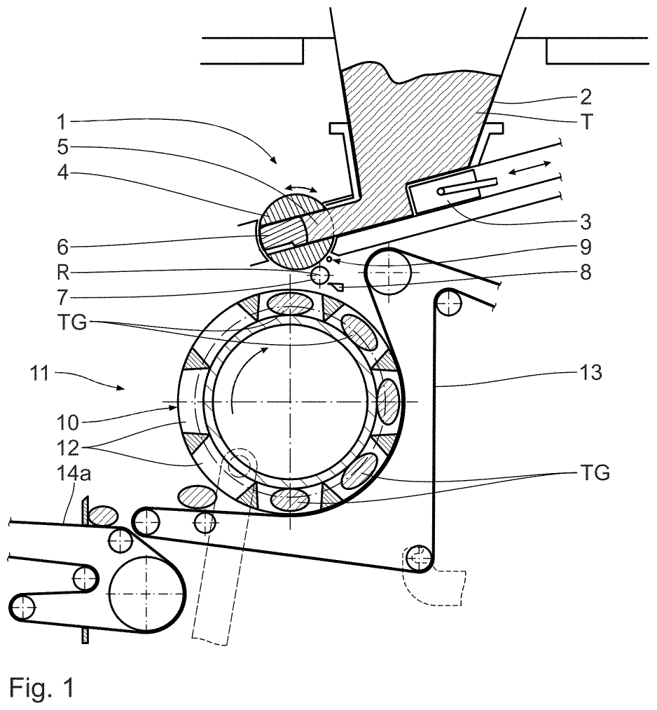

A dough processing installation according to FIG. 1, designed as a dough dividing/kneading device, has a conventional dough dividing device 1 with a storage hopper 2 for the dough T, a pusher 3 arranged below it and a dosing drum 4. Via the pusher 3, a partial quantity of the dough T is sheared off and filled into a dosing chamber 5 in the dosing drum 4, which is bounded by an ejector piston 6. By rotating the dosing drum 4 counterclockwise or clockwise with respect to FIG. 1, the dosing chamber 5 is brought into a downward rotational position and at the same time the ejector piston 6 is moved in a radial direction so that the dough piece TG in the dosing chamber 5 is ejected downwards.

The dough processing installation is designed with four rows, i.e. it can divide, dose and knead four parallel rows of dough pieces separately. Depending on the design, the dough processing installation can also be designed with one row or with another number of rows.

In order to support the detachment of the dough piece TG from the ejector piston 6, a dropping roller 7 is arranged underneath the dosing drum 4 next to the ejector position of the dough piece TG, which is driven in counterclockwise or clockwise rotation with respect to FIG. 1, and whose axis of rotation R is directed parallel to the axis of rotation of the dosing drum 4. The dropping roller 7 acts on the dough piece TG emerging from the dosing chamber 5 in such a way that it is detached from the ejector piston 6.

On the side of the dropping roller 7 facing away from the dosing drum 4, a scraper 8 is arranged parallel to the drum to counteract clogging of the dropping roller 7. Furthermore, an oiling device 9 is provided above the dropping roller 7.

A kneading drum 10 of a dough kneading device 11 of the dough processing installation is arranged below the dosing drum 4 and the dropping roller 7. The kneading drum 10 has kneading chambers 12 distributed over its circumference and a kneading belt 13 running over a partial circumference of the kneading drum 10. The kneading belt 13 abuts the kneading drum 10 over a circumferential portion. The kneading drum 10 serves to define lateral boundaries, i.e. side walls of the kneading chambers 12, and to define a radially inner boundary for the kneading chambers 12, i.e. the bottoms of the kneading chambers 12. The outer kneading belt 13 serves to define a radially outer boundary for the kneading chambers 12. The kneading belt 13 serves to close the kneading chambers 12 in the region of the abutting circumferential portion.

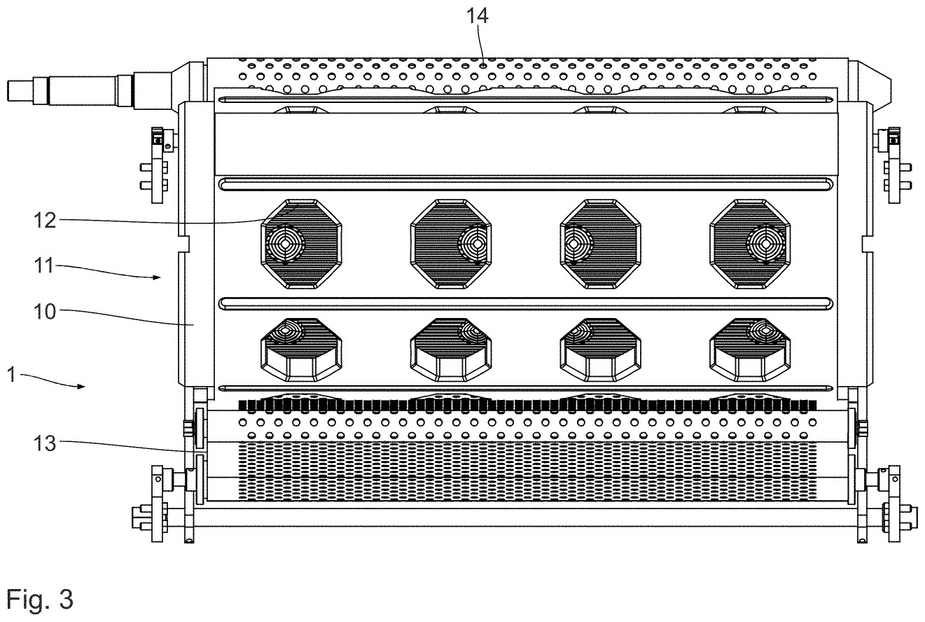

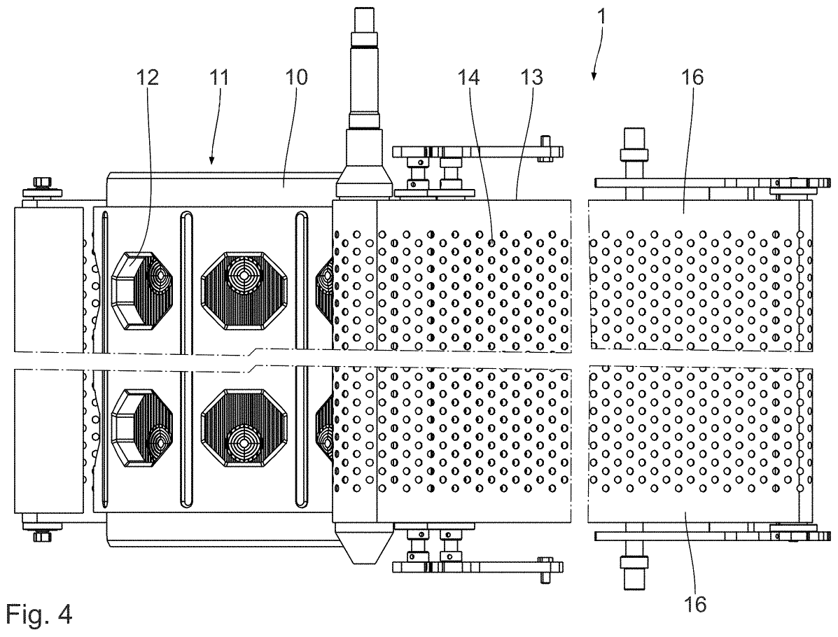

The kneading chambers 12 have a hexagonal cross-section (cf. in particular FIGS. 3 and 4). This cross-section can also be round or rectangular or polygonal in another way.

During filling, one dough piece TG at a time falls into the kneading chambers 12 after being detached from the dosing drum 4. During the clockwise rotation of the kneading drum 10, with reference to FIG. 1, each dough piece TG is subjected to a kneading treatment in the usual manner and then transported individually to the next processing station via a discharge belt 14a.

The kneading belt 13 has a plurality of passage openings 14 with a typical opening diameter which is smaller than 12 mm. This typical diameter of the passage openings 14 can be 5 mm.

The typical diameter of the kneading chambers 12 is the diameter of a sphere with the same volume as the volume of the respective kneading chamber 12.

The typical diameter of the respective passage opening 14 is the diameter of a circle with the same surface area as the area of this passage opening 14.

The passage openings 14 can have a diameter in the range of e.g. between 0.5 mm and 12 mm.

The passage openings 14 can be formed with a round or polygonal cross-section. The passage openings 14 can be formed hexagonally in cross-section. In the case of a polygonal design of the passage openings 14, these can be bounded by sides with equal and unequal side lengths, for example square or as a regular hexagon. The passage openings 14 can also be of triangular or oval design, or of unevenly edged design. The corners of these passage openings 14 can be rounded.

The passage openings 14 in the kneading belt 13 are arranged in the form of a hexagonal grid. Other arrangements of the passage openings 14 on the kneading belt 13, e.g. in rows and/or columns, are also possible. The arrangement of the passage openings 14 on the kneading belt 13 is preferably such that at least some of the passage opening lines which follow one another in a running direction 15 of the kneading belt 13 and which run transversely to the running direction 15 are arranged offset from one another. A completely random distribution or an otherwise irregular/asymmetrical/aperiodic passage opening arrangement is also possible.

In one variant of the kneading belt 13, it can have several types of passage openings 14 of different sizes.

Due to the passage openings 14, a contact surface of the kneading belt 13 is reduced, with which the kneading belt 13 comes into contact with the dough pieces to be kneaded.

The kneading belt 13 is formed continuously, i.e. without passage openings, in edge regions 16 running transversely to the running direction 15.

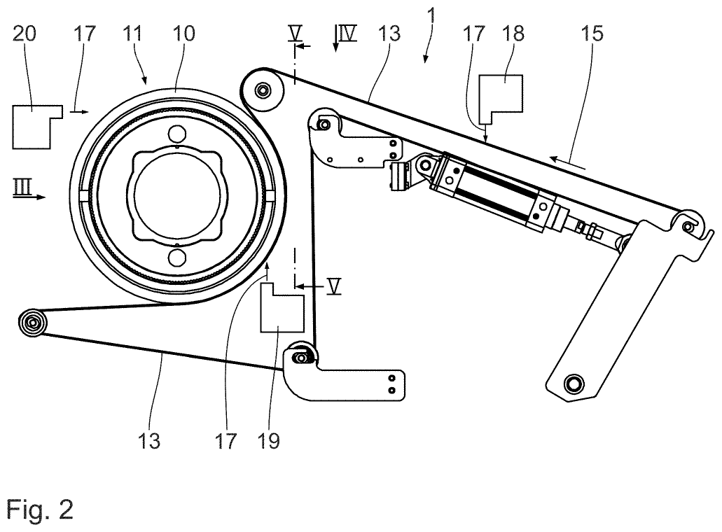

A plurality of blowers 18, 19, 20 of the dough kneading device 11 serve to blow drying air 17 onto the kneading belt 13 and the kneading chambers 12 (cf. FIG. 2). Preheated or non-preheated air can be used as drying air 17 with the aid of the blowers 18 to 20.

One of these blowers, the blower 18, is arranged above a kneading belt portion upstream from the abutting circumferential portion of the kneading drum 10 and opposite a pneumatic tensioning device for tensioning the kneading belt 13, which is shown in FIG. 2. This blower 18 is arranged in such a way that the drying air 17 exclusively impinges on the kneading belt 13, but not on the kneading chambers 12. The blower 18 is used to dry the kneading belt 13 before it abuts the circumferential side of the kneading drum 10.

The further blower 19 is arranged below the circumferential portion via which the kneading belt 13 abuts the kneading drum 10 to close the kneading chambers 12. This blower 19 therefore impinges on the kneading belt 13 in the abutting circumferential portion of the kneading drum 10 and, since the impinging drying air 17 which is emitted by the blower 19 penetrates the passage openings 14 of the kneading belt 13, also on the kneading chambers 12 and the dough pieces TG contained therein (see FIG. 1).

The other blower 20 is arranged in the region of the other circumferential portion of the kneading drum 10, over which the kneading belt 13 does not abut the kneading drum 10. The drying air 17, which is emitted by the blower 20, thus impinges exclusively on the kneading chambers after the kneaded dough pieces have been discharged from the kneading chambers 12. The blower 20 thus serves to dry the kneading chambers 12 before they are filled again with dough pieces TG for kneading.

The passage openings 14 in the kneading belt 13 reduce or completely prevent the dough pieces TG from sticking to the kneading belt 13 when the dough pieces are kneaded in the kneading chambers 12. A contact surface between the kneading belt 13 and the respective dough piece is reduced during kneading, compared to a kneading belt without passage openings. The addition of flour to prevent the dough pieces from adhering in particular to the kneading belt 13 can be reduced or even completely avoided.

If there is a tendency for the dough pieces to stick to the kneading belt 13 and/or the other walls of the kneading chambers 12 in the case of certain, moister types of dough, at least one of the blowers 18 to 20 described above can be used, or two of these blowers or even all three of these blowers can be used. The blower 18 can be used to pre-dry the kneading belt 13 so that it is dry when it comes into contact with the dough pieces TG for kneading in the kneading chambers 12, which reduces the tendency to stick. The blower 19 used alternatively or additionally ensures drying of the kneading belt 13 on the one hand and drying of the other walls of the kneading chambers 12 on the other hand, since the drying air 17 passes through the passage openings 14 in the kneading belt 13. At the same time, the drying air 17 which is emitted by the blower 19 also ensures that the dough pieces TG dry up, which is also referred to as stiffening. These drying measures by the blower 19 all lead to a reduction in the tendency of the dough pieces TG to stick to the walls of the kneading chambers 12 and to the kneading belt 13. The blower 20, which can also be used alternatively or additionally, ensures that the kneading chambers 12 are pre-dried before they are filled again with dough pieces TG. A tendency of the dough pieces TG to adhere to the then dried walls of the kneading chambers 12 is thus reduced or completely avoided.

In an alternative embodiment, the kneading belt 13 is designed as a woven belt. The passage openings in the manner of the passage openings 14 are then located between the warp and/or the weft yarns of a woven fabric of the kneading belt 13. In this case, the passage openings are so large that an air permeability of the kneading belt 13 results.

The dough kneading device 11 can be used to knead dough pieces TG with more than 45 l of liquid per 100 kg of dough, e.g. 52, 55, 62 or more than 62 l of liquid per 100 kg of dough. Semi-liquid and pasty ingredients such as liquid egg, butter or margarine are also to be counted proportionally to the liquid quantity.

What is claimed is:

1. A dough kneading device (11), comprising:
a kneading drum (10) for predefining bottoms and side walls of kneading chambers (12) for receiving dough pieces (TG) to be kneaded; and
a kneading belt (13) which over a circumferential portion abuts the kneading drum (10) for closing the kneading chambers (12),
wherein the kneading belt (13) has a plurality of passage openings (14) with a typical diameter which is smaller than 12 mm,
wherein the kneading belt (13) with the passage openings (14) is designed in such a way that, via a use of the kneading belt (13) with the passage openings (14), a contact surface between the kneading belt (13) and the dough pieces (TG) to be kneaded is reduced during operation of the dough kneading device (11).

2. The dough kneading device according to claim 1,
wherein the kneading belt (13) is a woven belt,
wherein the passage openings (14) are present between at least one of warp yarns or weft yarns of a fabric of the kneading belt (13).

3. The dough kneading device according to claim 1, wherein a diameter of the passage openings (14) is larger than 0.5 mm.

4. The dough kneading device according to claim 1, wherein the passage openings (14) have a round shape, a polygonal shape, a rounded polygonal shape, or an oval shape.

5. The dough kneading device according to claim 1, wherein the passage openings (14) are arranged in a hexagonal grid.

6. The dough kneading device according to claim 1, wherein the passage openings (14) are arranged in rows and columns, wherein at least some of the rows of the passage openings succeeding one another in a running direction (15) of the kneading belt (13) and extending transversely to the running direction (15) are arranged offset from one another.

7. The dough kneading device according to claim 1, wherein the kneading belt (13) has multiple types of passage openings (14) of different sizes.

8. The dough kneading device according to claim 1, further comprising at least one blower (18, 19, 20) for blowing drying air (17) onto at least one of the kneading belt (13) or the kneading chambers (12).

9. The dough kneading device according to claim 8, wherein the at least one blower (18) is arranged in such a way that the drying air (17) exclusively impinges on the kneading belt (13).

10. The dough kneading device according to claim 8, wherein the at least one the blower (20) is arranged in such a way that the drying air (17) exclusively impinges on the kneading chambers (12).

11. The dough kneading device according to claim 8, wherein the at least one blower (19) is arranged in such a way that the drying air (17) impinges on the kneading chambers (12) in a circumferential portion over which the kneading belt (13) abuts the kneading drum (10) for closing the kneading chambers (12).

12. A dough dividing and kneading device with the dough dividing device (1) and a dough kneading device (11) according to claim 1.
